(19) United States
(12) Patent Application Publication
(10) Pub. No.: US 2006/0072445 A1
(43) Pub. Date: Apr. 6, 2006

(54) Optical recording medium having abrasion resistance and antistatic properties

(75) Inventor: Ramon F. Hegel, North St. Paul, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/953,201

(22) Filed: Sep. 28, 2004

(51) Int. Cl. G11B 7/24

(52) U.S. Cl. 369/275.1; 369/272.1

(57) ABSTRACT

An optical disc comprising a transparent substrate, an information recording layer, said optical disc comprising a read/write surface and an opposing surface, at least one surface of said disc comprising a surface coating, wherein said at least one surface of said disc shows a change of reflectivity after 100 taber abrasion cycles of no more than 20%, a resistivity no greater than about 9—10¹³ ohms/square, and a static decay of less than about 0.5 seconds when tested at about 20° C. and 50% relative humidity.

### THE FIELD OF THE INVENTION

The present invention relates generally to optical recording media having a hard protective layer which has both abrasion resistance and antistatic properties.

### BACKGROUND OF THE INVENTION

Optical recording media typically comprise an optical recording layer on a substrate. For media such as magneto-optical disks, information is stored on a thin film of magneto-optical material disposed between two protective layers. Compact discs and digital video discs may have a reflective optical recording layer.

The basic principal of operation for the discs is to use a laser to locally raise the temperature of the magneto-optical layer to near the Curie point and switch the direction of the local magnetization to the direction of a recording magnetic field applied to the disk. The two protective layers enclose the magneto-optical material to protect it from corrosion, and are formed from materials such as silicon nitride, silicon oxide, or aluminum nitride dielectrics. The read/write head of a recording mechanism glides above the disk surface. Lubricants are disposed on the surface to protect both the disk head and the disk surface from damage. The lubricants reduce friction between the disk head and surface and they enhance the wear resistance of the disk.

Substrates are typically formed from materials such as polycarbonate or polymethylmethacrylate, materials which have excellent rigidity, transparency and dimensional stability, but poor abrasion resistance. For protection of the substrate, a “hard coat” layer is frequently coated onto at least one surface of the substrate to form a protective barrier therefor. The hard coat layer may be formed from a radiation-curable resin such as an acrylic polymer. Hard coats have also been formed from inorganic materials such as silicon oxides. However, the hard coat layer typically builds up static which attracts dust to the surface, which can obscure the surface from read/write beams from reaching the optical recording layer, so antistatic agents are either added to the surface or incorporated into the hard coat layer. Useful antistatic agents must be transparent, abrasion resistant and compositionally stable so that the agent doesn't interfere with the read/write function, nor reduce the abrasion resistance of the hard coat layer. Antistatic agents have been mixed with other ingredients of the hard coat before coating in some cases, and have also been added atop the deposited hard coat in others. Each of these methods has advantages and disadvantages, depending on the particular ingredients and their properties.

It has now been discovered that an optical recording disc including a transparent substrate and an information recording layer, where one or both of the read/write surface and the opposing surfaces are coated with an ultra-violet light curable hard surface coating, will show a change of reflectivity on the coated surface after 100 taber abrasion cycles of no more than 20%. The coated surface will exhibit a resistivity no greater than about 10¹³ ohms/square, and a static decay of less than about 0.5 seconds. The static decay number is less than 0.5 seconds when tested at about 20° C. and 20% relative humidity (RH), and when tested at about 20° C and 50% relative humidity.

### SUMMARY OF THE INVENTION

The invention provides an optical recording medium having a surface coating on at least one surface. The optical recording medium exhibits excellent abrasion resistance and antistatic properties.

Specifically, the invention provides an optical disc comprising a transparent substrate, an information recording layer, said optical disc including a read/write surface and an opposing surface, at least one surface of said disc comprising a surface coating, wherein said at least one surface of said disc:

a) exhibits a change of reflectivity after 100 taber abrasion cycles of no more than 20%,

b) exhibits a resistivity no greater than about 9×10¹³ ohms/square, and

c) exhibits a static decay of less than about 0.5 seconds when tested at about 20° C. and 50% relative humidity.

In one embodiment, the invention provides an optical recording medium exhibiting

a) a scratch depth of less than 30 nm at a scratch force of 40 μN,

b) a resistivity no greater than about 9×10¹³ ohms/square, and

c) a static decay of less than about 0.5 seconds when tested at about 20° C. and 50% relative humidity.

In another embodiment, the invention provides an optical recording medium wherein said surface coating has a thickness of from about 2.5 to about 3.5 microns.

In another embodiment, the invention provides an optical disc comprising a surface coating on at least one surface which comprises at least one urethane polyacrylic ester.

In another embodiment, the invention provides a surface coating useful for coating optical recording media, wherein a transparent substrate coated with said surface coating shows a change of reflectivity after 100 taber abrasion cycles of no more than 20%, a resistivity no greater than about 9×10¹³ ohms/square, and a static decay of less than about 0.5 seconds when tested at about 20° C. and 50% relative humidity, and a scratch depth less than 30 nm at a scratch force of 40 μN.

In another embodiment, the invention provides a surface coating useful for coating optical media which comprises at least one urethane polyacrylic ester.

In another embodiment, the invention provides a surface coating useful for coating optical media which comprises at least one urethane polyacrylic ester and at least one lithium perfluoroalkyl sulfonate salt.

These terms when used herein have the following meanings.

1. The term “coating composition” means a composition suitable for coating onto a substrate.

2. The terms “layer” and “coating” are used interchangeably to refer to a coated composition.

4. The term “resistivity” means the surface electrical resistance measured in Ohms/square.

5. The term “Tg” means glass transition temperature.

6. The term “lubricant” means a substance introduced between two adjacent solid surfaces, at least one of which is capable of motion, to produce an antifriction effect between the surfaces.

7. The term “hardcoat” means a protective surface layer.

8. The term “colorless” as used herein means that the component has an absorbance for visible radiation (i.e., from about 400 to 600 nm) of less than about 0.1.

9. The term “taber” refers to an abrasion test procedure using abrasive wheels described in ISO 9352.

All weights, amounts and ratios herein are by weight, unless otherwise specifically noted.

### DETAILED DESCRIPTION OF THE PREFERRED EMBODIMENTS

The following detailed description describes certain embodiments and is not to be taken in a limiting sense. The scope of the present invention is defined by the appended claims.

The optical recording medium includes a substrate, an optical recording layer, and a protective layer. The various components are described in greater detail below. In general terms, however, the magnetic layer includes either a thin metal coating or a primary magnetic metal pigment, and a binder for the pigment. The substrate has high dimensional stability related to the recording head and may comprise metal or glass.

In one embodiment, the invention is an optical disc including a transparent substrate, an information recording layer and a protective layer. The optical disc has a read/write surface and an opposing surface and the protective layer is coated onto the read/write surface.

Substrate

Useful substrates for optical discs are light-transparent materials. Substrates are typically made of glass or thermoplastic resins such as polycarbonate or polymethyl methacrylate and have a coating made from a UV-curable acrylic resin. The substrate may be a single layer or a plurality of layers. If a plurality of layers is used, the layers may be the same or different. The layers are formed by conventional methods such as casting, extrusion, injection molding, lamination, spin coating, screen printing, and the like.

The surfaces of the substrate layers are typically scored with guide grooves, such grooves having a substantially uniform depth of less than a micron. The grooves are spaced concentrically at intervals of about one or two microns.

Functional Layers

Optical recording media according to the invention store information in a thin film of magneto-optical material. This material is disposed on the substrate. The magneto-optical layers may be formed with any suitable materials exhibiting magneto-optical effects, e.g., amorphous vertically magnetized film based on rare earth transition metals, as these materials provide large magneto-optical effects.

Dielectric layers may also be present to enhance the apparent magneto-optical effects by providing interference between various layers of the optical medium. Typically, two dielectric layers are provided, surrounding the information recording layer.

Reflective layers are provided to increase the reflectance of the medium and increase the read back signal output from the optical recording medium. Useful reflective layers include gold, aluminum or alloys thereof.

Optical recording media according to the invention may be formed on a transparent substrate by successively laminating layers thereon or by vacuum film forming operations such as sputtering and vapor deposition. The first layer deposited is typically a dielectric layer, followed by one or more magnetic recording layers, at least one reflective layer, the protective layers, and the like until all layers are coated. The surface of the disk is then cleaned and/or surface treated so as to be free of impurities. The disk may be cleaned with a mild solvent or treated by means of oxygen plasma for a period of a few seconds prior to application of a lubricant to the surface. Lubricants may be applied by submerging the optical medium, and then draining or pumping lubricant solution over the recording medium and then draining.

The Protective Layer

The abrasion-resistant and anti-static protective layer, or “hardcoat” provided herein enables an optical disc coated therewith to exhibit improved abrasion and antistatic properties. Optical discs coated with the protective coat have a scratch depth less than 30 nm scratch depth at a scratch force of 40 μN pencil hardness of at least F, when a substrate is used that would otherwise have a scratch depth of more than 30 nm at a scratch force of about 8 μN.

With regard to antistatic properties, the surface of a disc having the protective coating applied thereto will exhibit a change of reflectivity after 100 taber abrasion cycles of no more than 20%, exhibit a resistivity no greater than about 9×10¹³ ohms/square, and exhibit a static decay of less than about 0.5 seconds when tested at about 20° C. and 20% relative humidity, and also when tested at about 20° C. and 50% relative humidity.

In one embodiment, the protective layer comprises a urethane polyacrylic ester, a composition containing a polyacrylic ester, a polymerization shrinkage modifier, and a source of free radicals. In one embodiment, the protective layer also contains a lithium perfluoroalkyl salt.

More specifically, one embodiment of the hardcoat comprises:

I. from 0 to 100 parts by weight of a colorless urethane polyacrylic ester;

II. correspondingly from 100 to 0 parts by weight of a composition containing;
(A) from about 30 to about 60% by weight of a polyacrylic ester;
(B) from about 20 to about 70% by weight of a polymerization shrinkage modifier; and
(C) from 0 to about 50% by weight of at least one solvent.

III. from 0 to about 5% by weight of I and II of a source of free radicals; and

IV. from 0 to about 5% by weight of I and II of at least one additive selected from a source of flow control, a slip agent, and antistatic additives.

The urethane polyacrylic ester useful herein as the first component (component I) has the formula 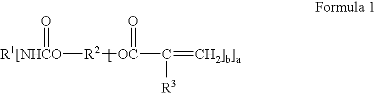
wherein:
R¹ has the valence “a” and is the residue remaining after the removal of —NCO groups from an organic polyisocyanate;
R² has the valence b+1 and is a polyvalent aliphatic group having 4 to 10 carbon atoms (preferably 5 carbon atoms and, optionally, one caternary oxygen atom);
R³ is —H or —CH₃;
a is a number having a value of at least 2; and
b is an integer of 3 to 5.

The composition useful as the second component (component II) herein contains:
(A) from 30 to 60% by weight of a polyacrylic ester of an alkane, a cycloalkane, or an azacycloalkane polyol, the polyol having up to 24 carbon atoms and the ester having 4 to 10 acryloyloxy groups and nitrogen, when present, being covalently bonded to the carbon of a carbonyl group:
(B) from 20 to 70% by weight of a polymerization shrinkage modifier; and
(C) from 0 to 30% by weight of one or more coating solvents.

The polymerization shrinkage modifier (part B of the second component) is preferably selected from the group consisting of
(1) a polymerizable carbamic compound having at least two groups select from groups having the formulae 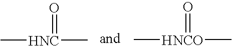
   and at least two acrylic groups per 168 to 2000 of molecular weight and a molecular weight of 168 to 5000, and
(2) a polymerizable poly(acryloyloxyalkoxy) alkane, cycloalkane or azacycloalkane defined hereinafter.

The polymerizable carbamic compound (part B(1) of the second component) is preferably selected from the group consisting of

(i) a carbamic ester having the formula 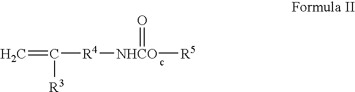
in which:
R³ is —H or —CH₃;
R⁴ is a divalent aliphatic group selected from —R⁶—and 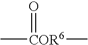
   in which —R⁶— is an alkylene group having 1 to 6 carbon atoms or a 5- or 6-membered cycloalkylene group having 5 to 10 carbon atoms;
R⁵ is a polyvalent linear structure obtained by removal of the hydroxyl groups from a monomeric or polymeric aliphatic polyol;
c is an integer of from 2 to 15 (preferably 3 to 6);

(ii) an acryloyloxyalkylisocyanurate of the formula 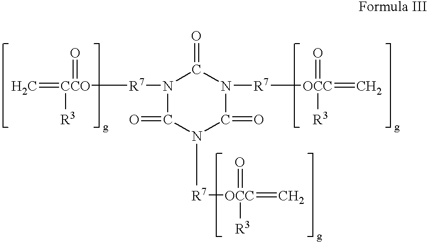
in which:
R⁷ is polyvalent aliphatic group selected from R⁶ and 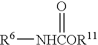
   in which R⁶ as defined for Formula II and R¹¹ has a valence of g+1 and is a polyvalent aliphatic group having 4 to 10 carbon atoms (preferably 5 carbon atoms) and, optionally, one catenary oxygen atom:
g is an integer of 1 to 3, and

(iii) a polyacrylamido compound having the formula 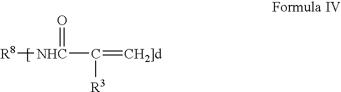
wherein:
R³ is defined above,
R⁸ is a linear, branched, or cyclic alkadiyl or -triyl group having 2 to 10 carbon atoms and optionally, up to 4 caternary oxygen atoms; and d is the integer 2 or 3.

The polymerizable material useful as part B(2) of the second component may be represented by the formula 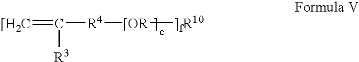
R³ and R⁴ are defined above;
R⁹ is alkylene group having from 2 to 4 carbon atoms;
e is a number having a value of 1 to 3;
f is an integer of from 3 to 6; and
R¹⁰ is a residue of an alkane cycloalkane, or azacycloalkane polyol having up to 24 carbon atoms wherein the nitrogen of the azacycloalkane is covalently bonded to the carbon of a carbonyl group.

The source of free radicals (the third component) comprises from 0 to 5% by weight of total parts of the first and second components of an energy-activatable source of free radicals.

The urethane polyacrylic ester of Formula I (the first component), is preferably prepared by reaction of one mole of di- or triisocyanate, respectively, with 2 to 2.2 moles or 3 to 3.3 moles of a polyacryloyloxyalkanol. The polyacryloyloxyalkanols can be considered as polyols having 4 to 10 carbon atoms and 4 to 6 hydroxy groups, of which all but about one hydroxyl group has been esterified with an acrylic acid. The term “acryloyloxy” as used herein includes both the acryloyloxy group and the methacryloyloxy group. Representative examples of useful polyacryloyloxyalkanols are pentaerythritol triacrylate, dipentaerythritol pentaacrylate, 2,2,3,3-tetra(acryloyloxymethyl)-propanol, arabitol tetraacrylate, and sorbitol pentaacrylate and the corresponding methacrylates.

Isocyanates that can be used in the preparation of the urethane polyacrylic ester include the aliphatic, cycloaliphatic, and aromatic polyisocyanates having at least two isocyanate groups. Such compounds are known and include 2,4-tolylene diisocyanate, 3,5,5,-trimethyl-1-isocyanato-3-isocyanatomethylcyclohexane (also called isophorone diisocyanate), hexamethylene diisocyanate, 1,3,5-tris(6-isocyanatohexyl- 1,3,5-triazine-2,4,6(1H, 3H, 5H)trione, 1,3-di(isocyanatoethyl)hydantoin,2,2,4-trimethylhexamethylene diisocyanate and 1,3,5-benzenetriisocyanate. Other suitable polyisocyanates are described in U.S. Pat. Nos. 3,641,199; 3,700,643; and 3,931,117, among others.

The polyacrylic ester useful as part A of the second component herein comprises one or more polyacrylic acid esters of an alkane, cycloalkane or azacycloalkane polyol, the polyol having up to 24 carbon atoms. Nitrogen, when present, is covalently bonded to a carbonyl group. Examples of such compounds include pentaerythritol tetraacrylate, dipentaerythritol hexaacrylate, pentaacryloyloxymethylethane, 3,3,7,7-tetra(acryloyloxymethyl)-5-oxanonane, arabitol pentaacrylate, sorbitol hexaacrylate and the corresponding methacrylates, and 1,3-bis(2-acryloyloxyethyl-5,5-dimethyl)-2,4-imidazolidinedione.

Carbamic esters (Part B(1)(i)) of the optical coating resin are preferably prepared by reacting one or more monoisocyanate-substituted, addition-polymerizable ethylenically-unsaturated organic compounds (such compounds being sometimes referred to hereafter as “ethylenically-unsaturated isocyanates”) with at least one polyol which can be any aliphatic monomeric or polymeric polyol. The polyol preferably is a polyester polyol, polyether polyol or polyacrylate polyol (such polyester polyols, polyether polyols, and polyacrylate polyols being sometimes referred to collectively hereafter as “polyols”), said polyols having at least two hydroxyalkyl or hydroxycycloalkyl groups per molecule. The amount of reactants and time of reaction are chosen so as to result in consumption of essentially all free isocyanate groups in the reaction mixture as determined by, for example, infrared analysis. Generally, about 0.8 to 1 mole of ethylenically-unsaturated isocyanates are used per mole of hydroxyl groups in the polyols. Preferably, the reaction between ethylenically-unsaturated isocyanates and polyols is carried out in the presence of a suitable catalyst such as dibutyltin dilaurate. The reaction is generally performed in a suitable mixing vessel under substantially anhydrous conditions at temperatures from about 25° C. to 100° C. for at least about one hour or more, utilizing batch or continuous processing.

Monomeric aliphatic and polymeric polyols which can be used to prepare the polymerizable carbamic ester resins for making the coatings of this invention preferably contain only carbon, hydrogen and oxygen, but can, if desired, contain other chain atoms (e.g., sulfur atoms) or substituent groups (e.g., chloromethyl groups) which do not interfere with the functioning of the polymerizable carbamic ester as an optical coating resin. They have at least two hydroxyl groups, a hydroxyl equivalent weight of 31 to 1000, preferably 59 to 300 and a molecular weight of 31 to 1000, preferably 59 to 300, and a molecular weight of 62 to 5000, preferably 118 to 2100.

The monomeric aliphatic polyols are those polyols that do not contain repeating units in contrast to the polymeric aliphatic polyols which can contain from 2 to about 100 units, such as —CH₂CH₂O—, that are connected together in a chain. Monomeric aliphatic polyols are well known and include, for example, alkane polyols such as ethylene glycol, 1,3-propylene glycol, 1,4-butylene glycol, glycerine, neopentyl glycol, trimethylolpropane, tetramethylolethane, pentaerythritol, dipentaerythritol, erythritol, arabitol and sorbitol.

Useful photoinitiators include acyloin and derivatives thereof such as methyl benzoyl formate, benzoin, benzoin methyl ether, benzoin ethyl ether, benzoin isopropyl ether, benzoin isobutyl ether, and alpha-methylbenzoin, alpha-hydroxy ketones, diketones such as benzil and diacetyl, organic sulfides such as diphenyl monosulfide, diphenyl disulfide, decyl phenyl sulfide, and tetramethylthiuram monosulfide, S-acyl dithiocarbamates such as S-benzoyl-N, N-dimethyldithiocarbamate, phenones such as acetophenone, alpha, alpha, alpha-tri-bromacetophenone, alpha, alpha-diethoxyacetophenone, ortho-nitro-alpha, alpha, alpha-tribromoacetophenone, benzophenone, and 4,4′-bis(dimethylamino)benzophenone, and sulfonyl halides such as p-toluenesulfonyl chloride, 1-naphthalenesulfonyl chloride, 2-naphthalenesulfonyl chloride, 1,3-benzenedisulfonyl chloride, 2,4-dinitrobenzenesulfonyl bromide and p-acetamidobenzenesulfonyl chloride. For curing techniques such as thermal energy and actinic radiation, the free-radical polymerization initiator is ordinarily used in amounts ranging from about 0.01 to 5 percent by weight compared to the total weight of coating resin. When the polymerization initiator quantity is less than about 0.01 percent by weight, the polymerization rate of the coating resin is slowed. When the polymerization initiator is used in amounts greater than about five percent by weight, no appreciable increase in polymerization rate is observed compared to compositions containing about five percent by weight of polymerization initiator. Preferably, from about 1.0 to about 5.0 percent by weight of polymerization initiator is used in the polymerizable coating resins of this invention cured by thermal energy or actinic radiation.

In one embodiment, the hard coat also contains (part IV) up to about 5% based on ingredients I and II of at least one lithium perfluoroalkyl sulfonate salt. Useful salts include lithium trifluoromethanesulfate, LiSO₃C₄F₉, LiN(SO₂CF₃)₂, and the like. The lithium salt is pre-mixed with the other materials prior to formation of the protective layer.

Adjuvants which are conventionally used in resins for optical coatings, such as inhibitors, antioxidants, UV absorbers, light stabilizers, dyes, flow agents, additional antistatic agents and the like can be added if desired. Useful flow agents include silicone flow agents, polyacrylate flow agents, and the like.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLES

The abrasion test uses an abrader in which two abrasive wheels are disposed at predetermined positions on a turntable. A sample is then placed on the turntable and a predetermined load of 500 grams is applied to the abrasive wheels and the turntable is rotated. During the rotation, the abrasive wheels abrade the surface. Taber CF 10 wheels were used, and the table was rotated for 100 cycles.

A disc having the inventive hardcoat showed a change in reflectivity of less than 10% after 25 taber cycles, and less than 20% after 100 taber cycles. A commercial DVD+R disc with no coating showed a change of 40% after 25 taber cycles and over 50% at 100 taber cycles.

### AFM NanoScratch Test

Samples of an uncoated polycarbonate substrate and coated polycarbonate substrate were subjected to the AFM test where a measure scratch force is applied to the substrate. The uncoated polycarbonate substrate has a scratch depth of 30 nm at a scratch force of 8 μN, and an identical substrate coated with the protective surface layer has a scratch depth of less than 30 nm at a scratch force of 40 μN.

### The Pencil Scratch Resistance Test

This test uses Mars Lumograph® drawing pencils with different lead hardnesses, e.g., number 4H lead, to 8B, and the like. Each of the pencils is used in sequential order of hardness to write on the surface of the disc. The hardness rating is the hardness of the first pencil lead that causes no scratch on the surface of the disc.

TABLE 1
Scratch Resistance: Pencil Hardness

| Sample | Pencil Hardness Rating |
|---|---|
| Polycarbonate Substrate | 6B |
| Polycarbonate Substrate with Hardcoat | F |
| Commercially available disc with | HB (light scratch with F) |
| Coating A | |
| Commercially available disc with | HB (light scratch with F) |
| Coating B | |

| | |
|---|---|
| [symbol] softer | harder → |

6B 5B 4B 3B 2B B HB F H 2H 3H 4H 5H 6H

### Static Decay Test

Sample discs having no initial charge (discharge if necessary) were charged for about 5000 volts and the time in seconds for the charge to decay to about 50 volts was measured. These measurements were made at 20% humidity 15 and 50% humidity.

TABLE 2

| | Resistivity (Ω) | Resistivity (Ω) |
|---|---|---|
| | 70° F. and | 70° F. and |
| Sample | 50% humidity | 20% humidity |
| Uncoated polycarbonate | >10¹⁴ | >10¹⁴ |
| disc substrate | | |
| Disc with Coating A | >10¹⁴ | >10¹⁴ |
| Disc w/inventive | >10¹⁴ | >10¹⁴ |
| Hardcoat without antistat | | |
| Disc w/inventive | ˜10¹³ | ˜10¹³ |
| Hardcoat with antistat | | |

What is claimed is:

1. An optical disc comprising a transparent substrate, an information recording layer, said optical disc comprising a read/write surface and an opposing surface, at least one surface of said disc comprising a surface coating, wherein said at least one surface of said disc:
a) exhibits a change of reflectivity after 100 taber abrasion cycles of no more than 20%,
b) exhibits a resistivity no greater than about 9×10¹³ ohms/square, and
c) exhibits a static decay of less than about 0.5 seconds when tested at about 20° C. and 50% relative humidity.

2. An optical disc according to claim 1, wherein said at least one surface of said disc exhibits fingerprint resistance such that the surface tension of said at least one surface is less than 30 dynes/cm.

3. An optical disc according to claim 2, wherein a disc with an identical substrate which does not include a protective layer has a surface tension of about 33 dynes/cm.

4. An optical disc according to claim 1, wherein said optical disc has a scratch depth less than 30 nm scratch depth at a scratch force of 40 μN.

5. An optical disc according to claim 4, wherein said disc also has a pencil hardness of at least F.

6. An optical disc according to claim 1, wherein said surface coating is provided on said read/write surface.

7. An optical disc according to claim 1, wherein said surface coating has a thickness no greater than about 5 microns.

8. An optical disc according to claim 1, wherein said surface coating has a thickness no greater than about 3.5 microns.

9. An optical disc according to claim 7, wherein said surface coating has a thickness of from about 2.5 to about 3.5 microns.

10. An optical disc according to claim 1, wherein said surface coating is provided on both surfaces of said disc.

11. An optical disc according to claim 1, wherein said surface coating comprises at least one urethane polyacrylic ester.

12. An optical disc according to claim 1, wherein said surface coating comprises at least one lithium perfluoroalkyl sulfonate salt.

13. An optical disc according to claim 12, wherein said perfluoroalkyl sulfonate salt is selected from the group consisting of lithium trifluoromethanesulfate, LiSO₃C₄F₉, and LiN(SO₂CF₃)₂.

14. An optical disc according to claim 1, wherein said surface coating comprises:
I. from 0 to 100 parts by weight of a colorless urethane polyacrylic ester;
II. correspondingly from 100 to 0 parts by weight of a composition containing;
A) from about 30 to about 60% by weight of a polyacrylic ester;
B) from 20 to 70% by weight of a polymerization shrinkage modifier; and
C) from 0 to about 50% by weight of at least one solvent;
III. from 0 to about 5% by weight of I and II of a source of free radicals; and
IV. from 0 to about 5% by weight of I and II of an additive selected from a flow control additive and an antistatic additive.

15. A surface coating useful for coating optical recording media, wherein a transparent substrate coated with said surface coating shows a change of reflectivity after 100 taber abrasion cycles of no more than 20%, a resistivity no greater than about 9×10¹³ ohms/square, and a static decay of less than about 0.5 seconds when tested at about 20° C. and 50% relative humidity.

16. A surface coating according to claim 16, wherein said substrate has a pencil hardness of 5B and a scratch depth of 30 nm at a scratch force of 8 μN, and an identical substrate coated with said protective surface layer has a pencil hardness of at least F and scratch depth of less than 30 nm at a scratch force of 40 μN.

17. A surface coating according to claim 16, wherein said substrate has a fingerprint resistance such that the surface tension of said at least one surface is about 33 dynes/cm and an identical substrate coated with said protective surface layer has a surface tension no greater than about 30 dynes/cm.

18. A surface coating for an optical disc comprising:
I. from 0 to 100 parts by weight of a colorless urethane polyacrylic ester;
II. correspondingly from 100 to 0 parts by weight of a composition containing;
A) from about 30 to about 60% by weight of a polyacrylic ester;
B) from about 20 to about 70% by weight of a polymerization shrinkage modifier; and
C) from 0 to about 50% by weight of at least one solvent;
III. from 0 to about 5% by weight of I and II of a source of free radicals; and
IV. from 0 to about 5% by weight of I and II of an additive selected from a flow control additive and an antistatic additive.
